(19) United States
(12) Patent Application Publication
(10) Pub. No.: US 2019/0390729 A1
(43) Pub. Date: Dec. 26, 2019

(54) COMBINED COMPOSITE AND METAL ENERGY ABSORBER

(71) Applicant: GM Global Technology Operations LLC, Detroit, MI (US)

(72) Inventors: Ryan Gergely, Fraser, MI (US); Bradley A. Newcomb, Troy, MI (US); Bhavesh Shah, Troy, MI (US)

(21) Appl. No.: 16/014,369

(22) Filed: Jun. 21, 2018

(51) Int. Cl. F16F 7/12

(52) U.S. Cl. CPC F16F 7/12; B62D 21/15

(57) ABSTRACT

A combined composite and metal energy absorber includes a composite structure and a first metallic tube with a first section and a second section, the first section being joined to the composite structure. The composite structure and the first metallic tube have a tailored crush profile to avoid premature crushing of any of the composite structure and the first metallic tube.

### INTRODUCTION

The present disclosure relates to an energy absorber. More specifically, the present disclosure relates to a combined composite and metal energy absorber.

It is advantageous to improve crush performance of vehicle components. Thus, vehicle components that exhibit adequate strength during both normal service and under extraordinary conditions such as collisions are advantageous. Current energy absorbers that employ both composite and metallic components, however, typically do not utilize the entire length of the energy absorber.

Thus, while current energy absorbers achieve their intended purpose, there is a need for a new and improved energy absorber that utilizes the entire energy absorber.

### SUMMARY

According to several aspects, a combined composite and metal energy absorber includes a composite structure and a first metallic tube with a first section and a second section, the first section being joined to the composite structure. The composite structure and the first metallic tube have a tailored crush profile to avoid premature crushing of any of the composite structure and the first metallic tube.

In an additional aspect of the present disclosure, the first section of the first metallic structure is positioned within a portion of the composite structure.

In another aspect of the present disclosure, the energy absorber further includes a second metallic tube wherein the second metallic tube is positioned over the second section of the first metallic tube.

In another aspect of the present disclosure, an initiation force profile and a propagation force profile of the first metallic tube is such that crushing initiates at a desired location in the first metallic tube and crush propagates along the first metallic tube without prematurely initiating crush somewhere else in the combined composite and metal energy absorber.

In another aspect of the present disclosure, an initiation force profile and a propagation force profile of the composite structure is such that crushing initiates at a desired location in the composite structure and crush propagates along the composite structure without prematurely initiating crush somewhere else in the combined composite and metal energy absorber.

In another aspect of the present disclosure, a crush force response profile of the combined composite and metal energy absorber is less than the force that prematurely crushes the composite structure.

In another aspect of the present disclosure, the propagation force increases with position in the composite structure.

In another aspect of the present disclosure, the propagation force increases with position in the first metallic structure.

In another aspect of the present disclosure, a crush force response profile of the combined composite and metal energy absorber is less than the force that prematurely crushes the second metallic tube.

In another aspect of the present disclosure, the first metallic tube has interlocking features that engage with the composite structure.

In another aspect of the present disclosure, the interlocking features are spiral thread features.

In another aspect of the present disclosure, the interlocking features are scalloped features that enable controlled deformation at an end of the first metallic tube.

In another aspect of the present disclosure, the first metallic tube has controlled deformation zones.

In another aspect of the present disclosure, the interlocking features are on the outer surface of the first metallic tube and the first metallic tube is positioned within the composite structure.

In another aspect of the present disclosure, the interlocking features are on the interior surface of the first metallic tube and the first metallic tube is positioned about the composite structure.

According to several aspects, an energy absorber includes a composite structure and a metallic tube joined to the composite structure. The metallic tube has interlocking features that engage with the composite structure.

In another aspect of the present disclosure, the composite structure and the metallic tube have a tailored crush profile to avoid premature crushing of any of the composite structure and the metallic tube.

A method of generating a crush response profile for a combined composite and metal energy absorber includes generating initiation and propagation force profiles for a composite structure, generating initiation and propagation force profiles for a first metallic tube, and combining the initiation and propagation force profiles of the composite structure and the first metallic tube to generate the crush response profile for the combined composite and metal energy absorber.

In another aspect of the present disclosure, the composite structure and the first metallic tube have a tailored crush profile to avoid premature crushing of any of the composite structure and the first metallic tube.

In another aspect of the present disclosure, the method further includes generating initiation and propagation force profiles for a second metallic tube and combining the initiation and propagation force profiles of the second metallic tube with the composite structure and the first metallic tube to generate the crush response profile for the combined composite and metal energy absorber.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A shows an example of a combined composite and metal energy absorber in accordance with the principles of the present invention;

FIG. 1B shows a tailored crush profile of a composite structure of the combined energy absorber shown in FIG. 1A;

FIGS. 2A-2D show the effect of component geometry on initiation and propagation force on the component;

FIGS. 3A-3G show a method for constructing a proposed crush force response profile for a combined composite and metal energy absorber in accordance with the principles of the present invention;

FIG. 3H shows a proposed crush force response profile for a combined composite and metal energy absorber in accordance with the principles of the present invention;

FIGS. 4A, 4B and 4C show side cross-sectional views of three components of a combined composite and metal energy absorber and their respective initiation and propagation profiles in accordance with the principles of the present disclosure;

FIGS. 5A and 5B show a proposed force displacement response of the combined energy absorber as the combined energy absorber is being crushed;

FIGS. 6A and 6B show a side cross-sectional view of a tubular connection for a composite-metallic assembly in accordance with the principles of the present disclosure;

FIGS. 7A and 7B show a side cross-sectional view of an alternative connection for a composite-metallic assembly in accordance with the principles of the present disclosure;

FIGS. 8A and 8B show a side cross-sectional view of yet another alternative connection for a composite-metallic assembly in accordance with the principles of the present disclosure;

FIG. 8C shows a side view of the composite-metallic assembly shown in FIGS. 8A and 8B;

FIGS. 9A, 9B and 9C show an end view of yet another alternative connection for a composite-metallic assembly in accordance with the principles of the present disclosure;

FIGS. 10A and 10B show a side cross-sectional view of yet another alternative connection for a composite-metallic assembly in accordance with the principles of the present disclosure;

FIGS. 11A and 11B show a side cross-sectional view of yet another alternative connection for a composite-metallic assembly in accordance with the principles of the present disclosure;

FIGS. 12A and 12B show a side cross-sectional view of yet another alternative connection for a composite-metallic assembly in accordance with the principles of the present disclosure; and

FIG. 13 shows a side cross-sectional view of yet another alternative connection for a composite-metallic assembly in accordance with the principles of the present disclosure.

### DETAILED DESCRIPTION

The following description is merely exemplary in nature and is not intended to limit the present disclosure, application, or uses.

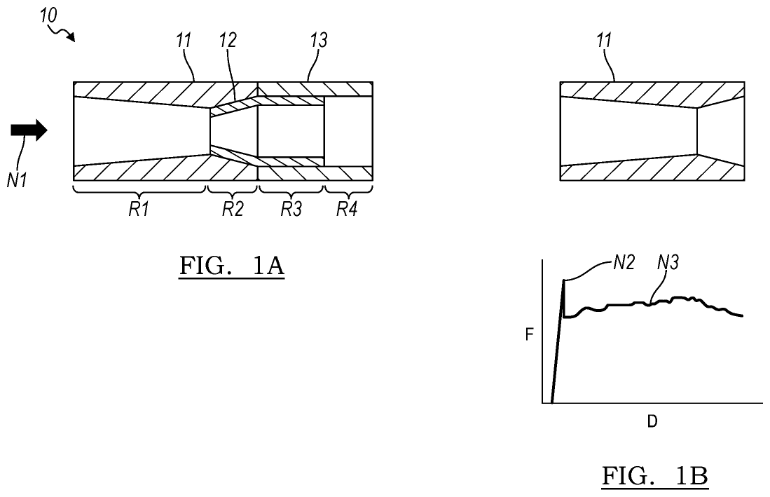

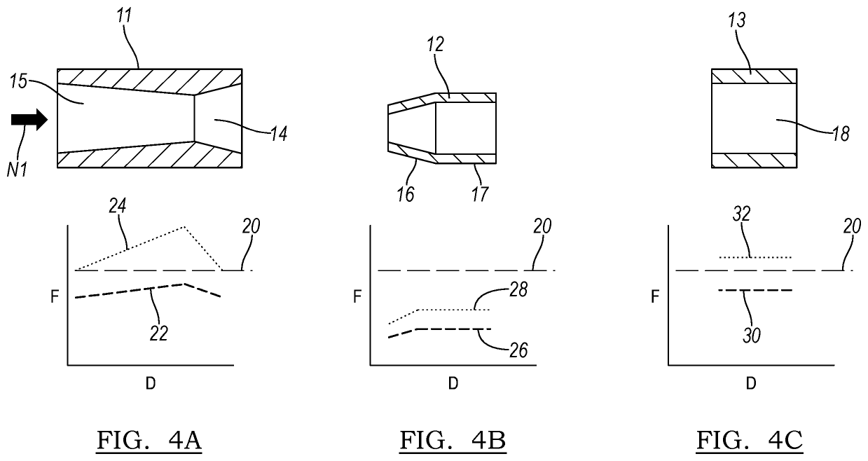

Referring to FIGS. 1A, 4A, 4B and 4C, there is shown a cross-sectional diagram along the length of a combined composite and metal energy absorber 10 with a composite structure 11, a first metallic tube 12 and a second metallic tube 13. The first metallic tube 12 is utilized as a metallic union to join the composite structure 11 and the second metallic tube 13 together. The crushing of the energy absorber 10 is initiated on the left side of the diagram and propagates in the direction indicated by the arrow N1.

The composite structure 11 has a first section 14 and a second section 15, while the first metallic tube 12 has a conical first section 16 and a cylindrical section 17. The conical section 16 mates with the interior of the first section 14 of the composite structure 11. The second metallic tube 13 has a generally cylindrical interior 18 that is positioned over the generally cylindrical section 17 of the first metallic tube 12.

Each of the components 11, 12 and 13 of the combined composite and metal energy absorber 10 has a tailored crush profile (Force vs Displacement). An example tailored crush profile for the composite structure 11 is shown in FIG. 1B. Characteristic features of the tailored crush profile are the initiation N2 and propagation N3 forces. At each position along the length of the crush of a particular component, the initiation and propagation force can be described. The initiation force is the force necessary for crushing to begin at that particular position along the length of the component. The propagation force is the force necessary to continue crushing the component as crush continues from the region of crush initiation through the particular position along the length of the component. In FIGS. 1A, 2A-2D and 4A-4C the propagation direction is from left to right as indicated by the arrow N1.

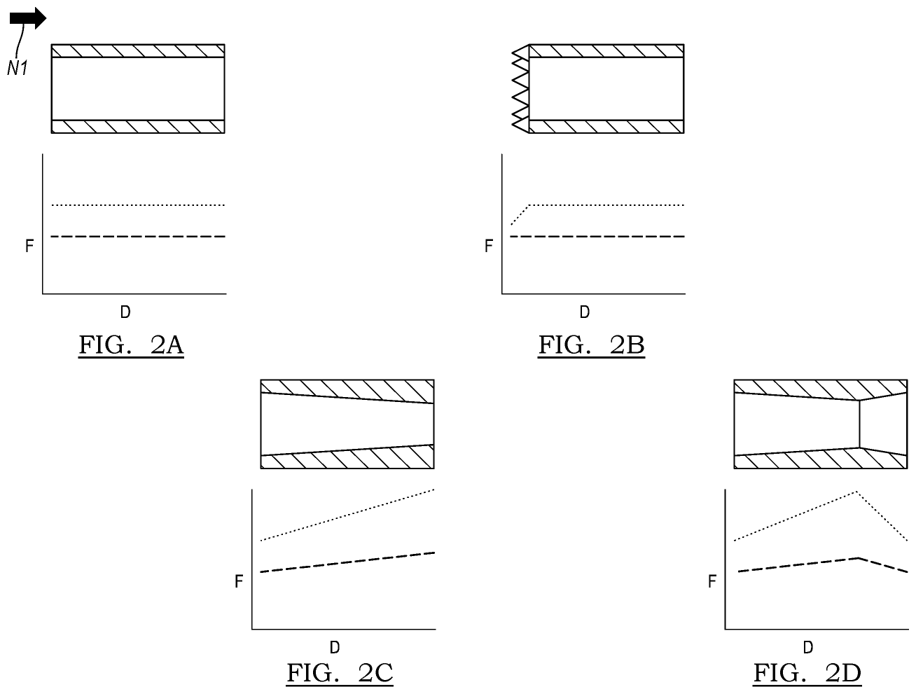

Both initiation and propagation force can be affected by the geometry or material properties of the crush structure. As an example, a crush structure with a constant cross section may have constant initiation and propagation force along the length of the structure as shown in FIG. 2A. Features on the end of the crush structure can be incorporated to reduce the initiation force, and control the location of crush initiation as shown in FIG. 2B. A taper in thickness can increase or decrease the initiation and propagation forces along the length of the crush structure as shown in FIGS. 2C and 2D. Note that in FIGS. 2A-2D and all subsequent figures, initiation forces are indicated by dotted lines and the propagation forces are indicated by dashed lines.

The initiation and propagation force profiles (Force vs Position along the length of the energy absorber or component) for each of the components in the combined composite and metal energy absorber 10 is plotted below each component in FIGS. 4A, 4B and 4C. Specifically, an initiation force 24 and a propagation force 22 for the composite structure 11 shows a rise in the force in the second section 15 and a decrease in force in the first section 14 along the length of the energy absorber. Similarly, an initiation force 28 and a propagation force 26 are shown for the first metallic tube 12, and an initiation force 32 and a propagation force 30 are shown for the second metallic tube 13. A line 20 indicates the minimum initiation force required at other positions along the length of the combined energy absorber 10 to avoid crush initiation at a location other than where desired (here at the left end of the energy absorber). Furthermore, the crush force response of the combined energy absorber 10 must not exceed the initiation force at any position further along the length of the energy absorber in the direction of crush propagation. Note, the initiation and propagation force of a single component of the combined energy absorber may be less than crush force response of the combined energy absorber, as indicated by line 20 (the initiation force of the combined energy absorber) in FIGS. 4A-4C. However, crush of the combined energy absorber 10 in regions with such components must be a combined response of multiple components to avoid premature crushing of the energy absorber 10.

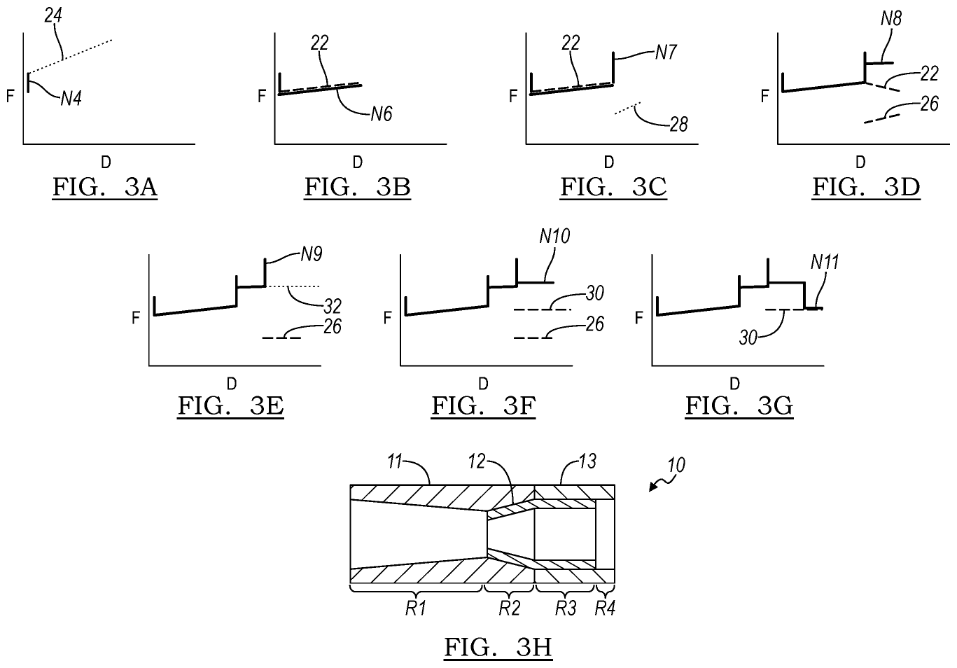

Assuming that the tailored crush profiles of the components 11, 12 and 13 are additive, FIGS. 3A-3G illustrate the steps for combining the initiation and propagation force profiles of each component to generate a proposed crush force response profile of the combined energy absorber 10 (FIG. 3H). Again, initiation forces are indicated by dotted lines and propagation forces are indicated by dashed lines; crush force response profiles are indicated by solid lines. The combined or joint effects may also be incorporated into this methodology with proper characterization, but are not included here for simplicity. The initiation force of the combined energy absorber is the lowest value of the initiation force profile. Crush will initiate at this position along the length of the combined energy absorber. In this example crush is intended to initiate on the left most side. The initiation force of the combined energy absorber N4 is taken from the leftmost end of the initiation profile 24 of the composite structure 11 (FIG. 3A). After crush initiation, the proposed crush force response profile N6 in the combined energy absorber 10 continues through region R1 as is indicated by the propagation profile 22 of the composite structure 11 (FIG. 3B). When crush reaches the overlapping region R2 of the composite structure 11 and first metallic structure 12, crush initiates in the conical section 16 of the first metallic structure 12. Here, the proposed crush force response profile N7 of the combined energy absorber 10 is the combination of the propagation profile 22 of the composite structure 11 and the initiation profile 28 of the first metallic structure 12 (FIG. 3C). After initiation of crush in the first metallic structure 12, the proposed crush force response profile N8 continues in this overlapping region R2 of the combined energy absorber 10 as a combination of the propagation profile 22 of the composite structure 11 and the propagation profile 26 of the first metallic structure 12 (FIG. 3D).

When crush reaches the end of the overlapping region of the composite structure 11 and first metallic structure 12, there is a transition into the overlapping region of the first metallic structure 12 and the second metallic structure 13. Using the same methodology, the proposed crush force response profile N9 of the combined energy absorber 10 is the combination of the propagation profile 26 of the first metallic structure 12 and the initiation profile 32 of the second metallic structure 13 (FIG. 3E). In the overlapping region R3 of the combined energy absorber 10 the proposed crush force response profile N10 is a combination of the propagation profile 26 of the first metallic structure 12 and the propagation profile 30 of the second metallic structure 13 (FIG. 3F). In the final region R4, the proposed crush force response profile N11 is the propagation profile 30 of the second metallic structure 13 (FIG. 3G).

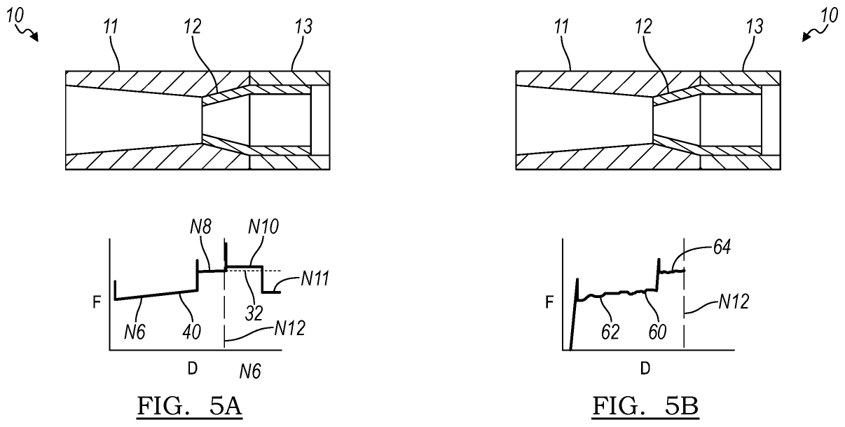

Turning to FIG. 5A, there is shown a resulting proposed crush force response profile 40 as the energy absorber is being crushed. At the transition between regions R2 and R3 the magnitude of the proposed profile exceeds that of the initiation profile 32 in region R4. Thus, if crush of the combined energy absorber 10 continues to this transition, crush will initiate in the second metallic structure 13 in region R4. With this result from the above describe methodology, a design decision can be made to mitigate unwanted crushing. Two options for design changes are (1) the crush length and thus design crush energy can be limited, or (2) the second metallic structure 13 can be redesigned to sustain higher crushing force.

By limiting the crush length N12, premature crush in region R4 can be avoided, and a proposed actual crush force response profile can be estimated. FIG. 5B shows an actual crush force response profile 60 with a crush length limited to regions R1 and R2 (which also limits allowable crush energy) during the crushing of the energy absorber 10.

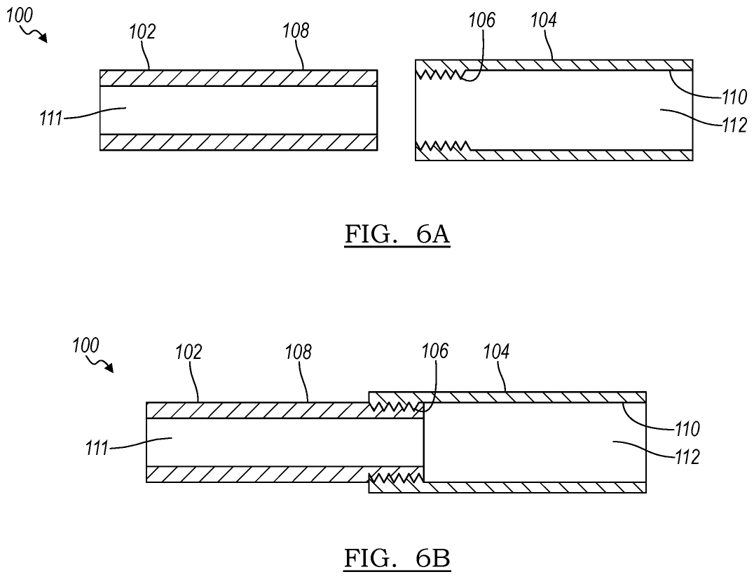

Turning now to FIGS. 6A and 6B, there is shown an assembly 100 with a composite tube 102 and a metallic tube 104. The composite tube 102 has an interior region 111 and an outer surface 108. The metallic tube 104 has an interior surface 110 defining an interior region 112. A set of interlocking features such as a set of teeth 106 are positioned on the interior surface 110. To join the composite tube 102 and the metallic tube 104 together, one or both components are heated. The composite tube 102 is then inserted into the interior region 112 such that the set of teeth 106 form a mechanical interlocking joint with the composite tube 102. Note that in other arrangements the composite tube is an outer tube and the metallic tube is an inner tube with the interlocking features being positioned on the outer surface of the metallic tube.

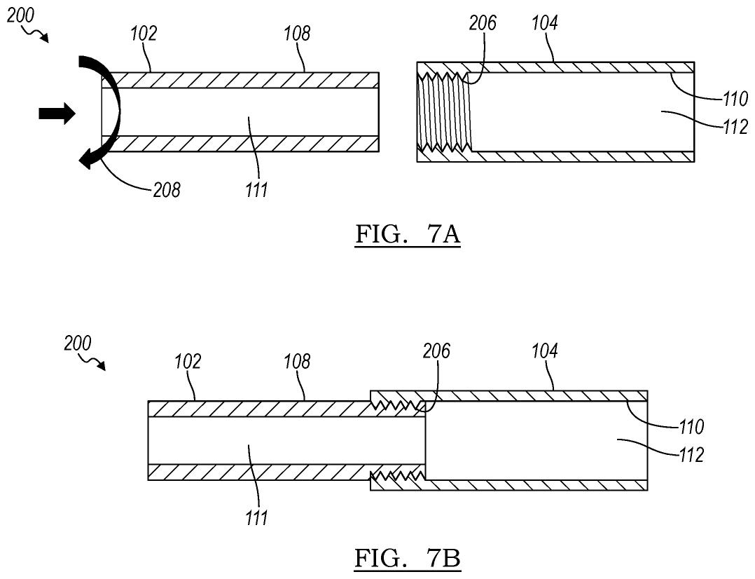

Turning now to FIGS. 7A and 7B, there is shown an assembly 200 with the composite tube 102 and the metallic tube 104. A set of interlocking features such as a threaded region 206 is positioned on the interior surface 110. To join the composite tube 102 and the metallic tube 104 together, on the composite tube 102 pressed and threaded into the interior metallic tube 104 as indicated by the arrow 208. Either or both the composite tube and the metallic tube may be heated prior to assembly of the structure 200. Note that in other arrangements the composite tube is an outer tube and the metallic tube is an inner tube with the threads being positioned on the outer surface of the metallic tube.

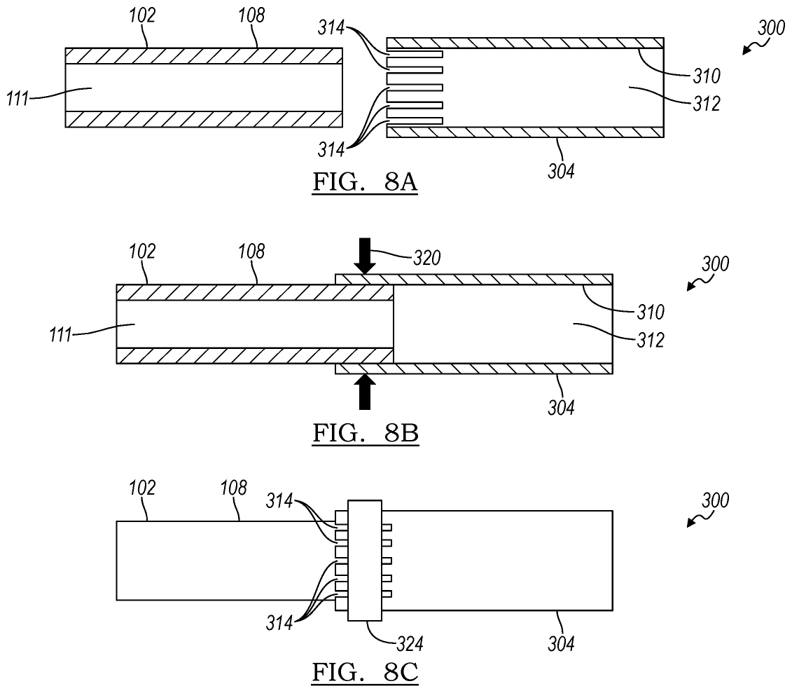

Turning to FIGS. 8A, 8B and 8C, there is shown an assembly 300 with the composite tube 102 and a metallic tube 304. The metallic tube 304 has an interior surface 310 defining an interior region 312. A set of compliant scalloped features 314 are formed at one end of the metallic tube 304. To join the composite tube 102 and the metallic tube 304 together, the composite tube 102 is inserted into the metallic tube 304 and a pressure 320 is applied to the scalloped features 314 to plastically deform the features into the composite tube 102. In some arrangements a tool 324 is utilized to apply the pressure 320. The tool 324 remains on the assembly 300 in certain arrangements.

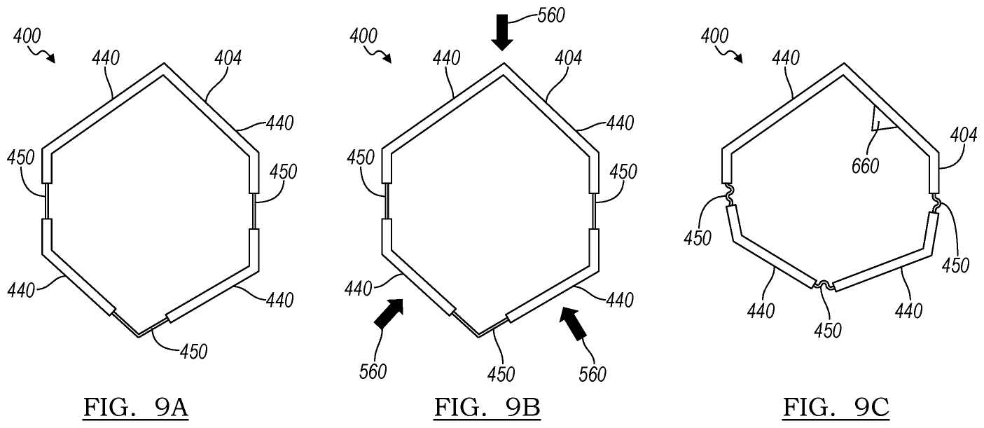

Referring to FIGS. 9A, 9B and 9C, there is shown a portion of an assembly 400 a metallic tube 404. Rather than the open scallops 314 described previously with respect to the metallic tube 304, the metallic tube 404 has controlled deformation zones 450 at the end of the tube positioned between wall sections 440 of the metallic tube 404. After the composite tube 102 is inserted into the end of the metallic tube 404, a pressure 560 is applied to the metallic tube 404, thereby causing the deformation zones 450 to deform such that metallic tube 404 joins with the composite tube 102. Note that the metallic tube 404, as well as the metallic tube 304, incorporate mechanical interlocking features 660 to engage the composite tube 102 in certain arrangements.

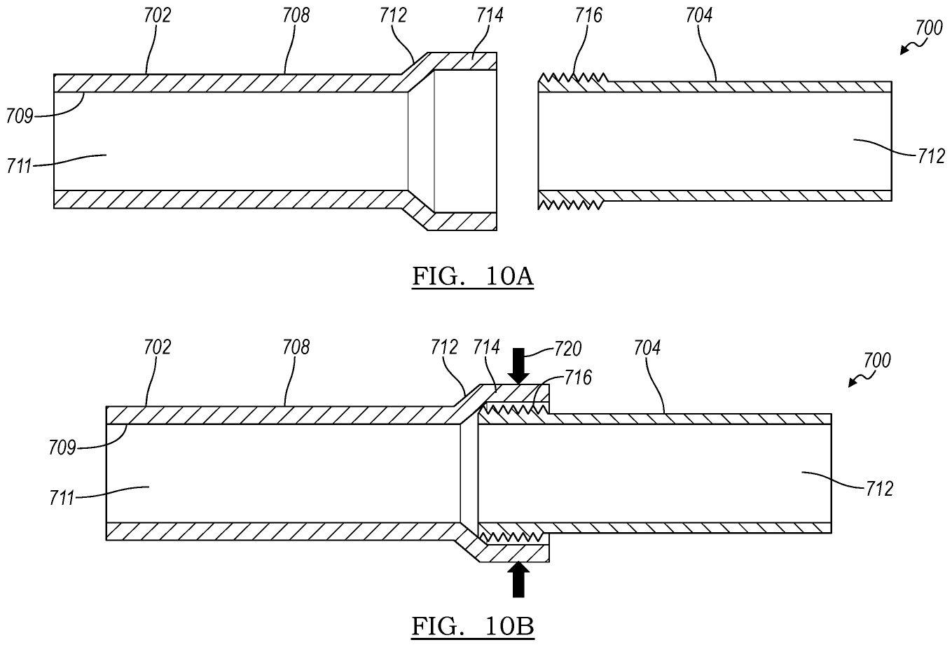

Turning to FIGS. 10A and 10B, there is shown an assembly 700 with a composite tube 702 and a metallic tube 704. The composite tube 702 has an interior region 711 and an outer surface 708. The composite tube has a flare in the tube in some arrangements or a step 712, 714 at the end of tube 702. The metallic tube 104 has an interior region 712 and a set of interlocking features 716, such as, for example, a set of teeth, on its exterior surface. To join the composite tube 702 and the metallic tube 704 together, one or both components are heated. The step region 712, 714 of composite tube 702 is then pushed over the interlocking features 716. Pressure 720 is applied to the step region 712, 714 such that the interlocking features 716 form a joint with the step region 712, 714.

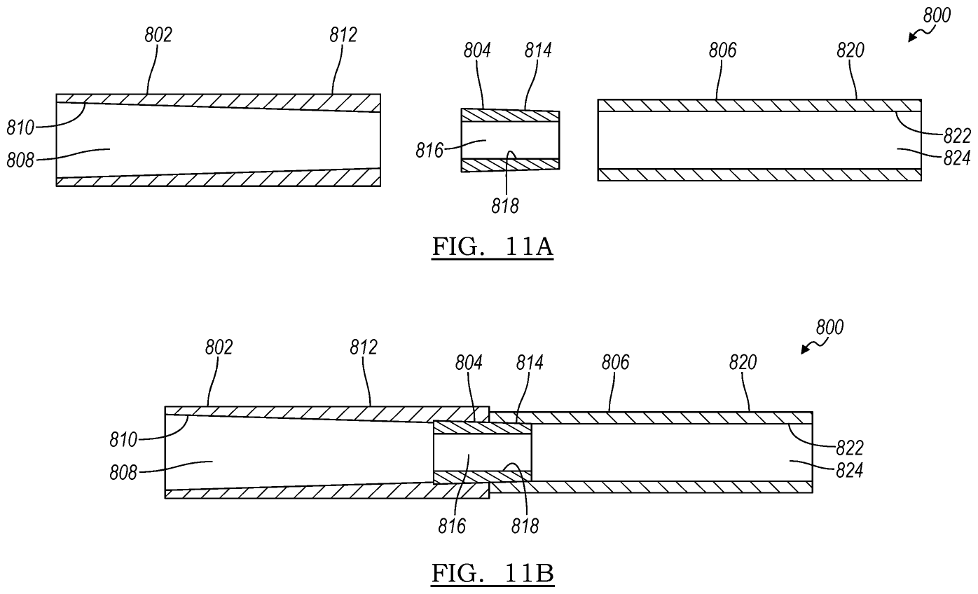

Turning now to FIGS. 11A and 11B, there is shown an assembly 800 with a composite tube 802 and a metallic tube 806 joined together with a tapered interface union 804 made of either a metallic material or a composite material. The composite tube 802 has an exterior surface 812 and interior region 808 with a tapered interior surface 810. The metallic tube 806 has an exterior surface 820 and an interior surface 822 that defines an interior region 824. The interface union 804 has an exterior surface 814 and an interior surface 818 that defines an interior region 816. To join the composite tube 802 and the metallic tube 806 together, the interface union 804 is placed into the composite tube 802 to form an interference fit as shown in FIG. 11B, while the interface union 804 and the metallic tube 806 form a metal to metal union in certain arrangements that can be joined together, for example, with flow drill screws.

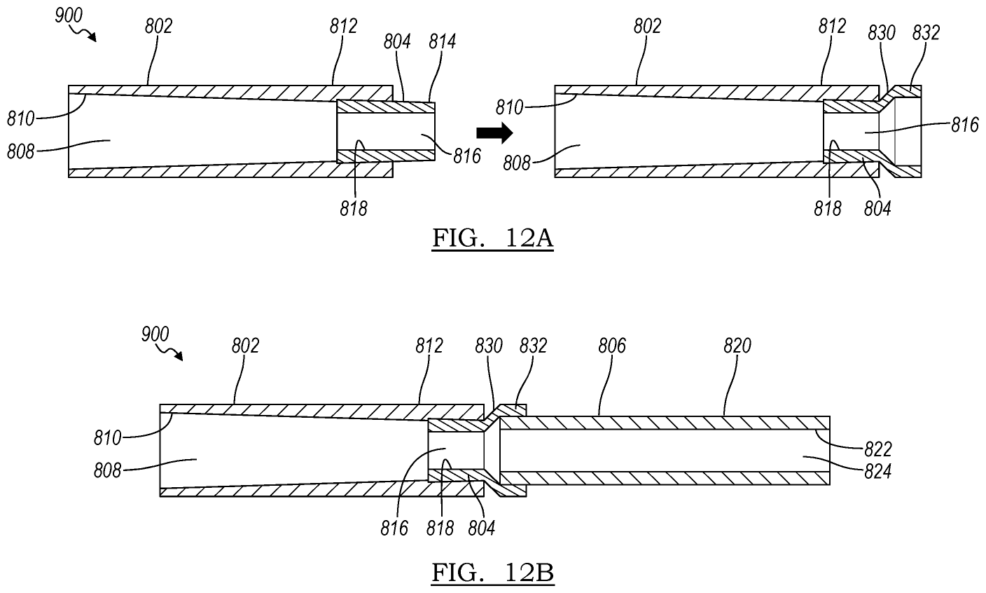

Referring to FIGS. 12A and 12B, there is shown another assembly 900 with the composite tube 802, the interface union 804, and the metallic tube 806. In this arrangement, the interface union 804 is again placed into the composite tube 802 to form an interference fit between the interface union 804 and the composite tube 802. The end of the interface union 804 is then formed or flared open to form a step region 830, 832 as indicated on the right hand side of FIG. 12A. The metallic tube 806 is then inserted into the flared region 830, 832 to join the metallic tube 806 to the composite tube 802.

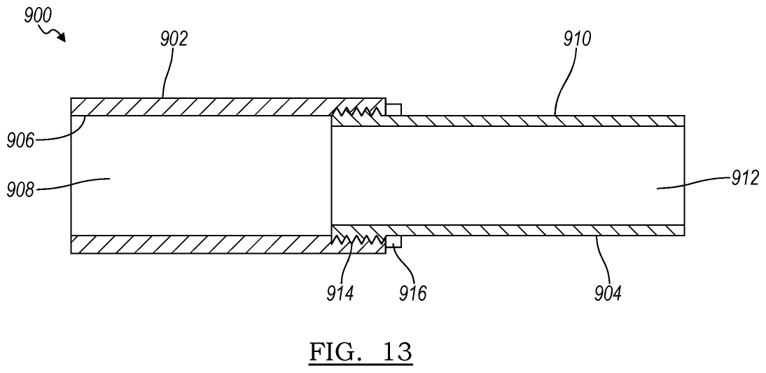

Turning now to FIG. 13, there is shown an assembly 900 with a composite tube 902 and a metallic tube 904. The composite tube 902 has an interior region 908 defined by an interior surface 906. The metallic tube 904 has an interior region 912 and an exterior surface 910 with a set of interlocking features such as a set of teeth 914. To join the composite tube 902 and the metallic tube 904 together, one or both components are heated. The set of interlocking features 914 is then inserted into the composite tube 902 such that the set of interlocking features 914 form a mechanical interlocking joint with the composite tube 902. The assembly 900 further includes a load carrying and position limiting feature 916.

In any of the assemblies described previously, the composite tube utilizes chopped or continuous fibers in a polymeric matrix in various arrangements. Suitable matrix materials include thermoplastics and thermosets. Fibrous material include carbon fibers, glass fibers, basalt fibers, para-aramid fibers, meta-aramid fibers, polyethylene fibers, and any combinations thereof. The reinforcing materials may be fabricated as woven fabric, continuous random fabric, discontinuous random fibers, chopped random fabric, continuous strand unidirectional plies, oriented chopped strand plies, braided fabric, and any combinations thereof.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A combined composite and metal energy absorber comprising:
a composite structure; and
a first metallic tube with a first section and a second section, the first section being joined to the composite structure,
wherein the composite structure and the first metallic tube have a tailored crush profile to avoid premature crushing of any of the composite structure and the first metallic tube.

2. The energy absorber of claim 1 wherein the first section of the first metallic structure is positioned within a portion of the composite structure.

3. The energy absorber of claim 1 further comprising a second metallic tube wherein the second metallic tube is positioned over the second section of the first metallic tube.

4. The energy absorber of claim 1 wherein an initiation force profile and a propagation force profile of the first metallic tube is such that crushing initiates at a desired location in the first metallic tube and crush propagates along the first metallic tube without prematurely initiating crush somewhere else in the combined composite and metal energy absorber.

5. The energy absorber of claim 1 wherein an initiation force profile and a propagation force profile of the composite structure is such that crushing initiates at a desired location in the composite structure and crush propagates along the composite structure without prematurely initiating crush somewhere else in the combined composite and metal energy absorber.

6. The energy absorber of claim 1 wherein a crush force response profile of the combined composite and metal energy absorber is less than the force that prematurely crushes the composite structure.

7. The energy absorber of claim 6 wherein the propagation force increases with position in the composite structure.

8. The energy absorber of claim 1 wherein the propagation force increases with position in the first metallic structure.

9. The energy absorber of claim 9 wherein a crush force response profile of the combined composite and metal energy absorber is less than the force that prematurely crushes the second metallic tube.

10. The energy absorber of claim 1 wherein the first metallic tube has interlocking features that engage with the composite structure.

11. The energy absorber of claim 10 wherein the interlocking features are spiral thread features.

12. The energy absorber of claim 10 wherein the interlocking features are scalloped features that enable controlled deformation at an end of the first metallic tube.

13. The energy absorber of claim 10 wherein the first metallic tube has controlled deformation zones.

14. The energy absorber of claim 10 wherein the interlocking features are on the outer surface of the first metallic tube and the first metallic tube is positioned within the composite structure.

15. The energy absorber of claim 10 wherein the interlocking features are on the interior surface of the first metallic tube and the first metallic tube is positioned about the composite structure.

16. A combined composite and metal energy absorber comprising:
a composite structure; and
a metallic tube joined to the composite structure;
wherein the metallic tube has interlocking features that engage with the composite structure.

17. The energy absorber of claim 16 wherein the composite structure and the metallic tube have a tailored crush profile to avoid premature crushing of any of the composite structure and the metallic tube.

18. A method of generating a crush response profile for a combined composite and metal energy absorber, the method comprising:
generating initiation and propagation force profiles for a composite structure;
generating initiation and propagation force profiles for a first metallic tube; and
combining the initiation and propagation force profiles of the composite structure and the first metallic tube to generate the crush response profile for the combined composite and metal energy absorber.

19. The method of claim 18 wherein the composite structure and the first metallic tube have a tailored crush profile to avoid premature crushing of any of the composite structure and the first metallic tube.

20. The method of claim 18 further comprising generating initiation and propagation force profiles for a second metallic tube and combining the initiation and propagation force profiles of the second metallic tube with the composite structure and the first metallic tube to generate the crush response profile for the combined composite and metal energy absorber.
